(19) United States
(12) Patent Application Publication
(10) Pub. No.: US 2024/0408708 A1
(43) Pub. Date: Dec. 12, 2024

(54) INGOT EDGE-POLISHING MACHINE TOOL

(71) Applicant: GlobalWafers Co., Ltd., Hsinchu (TW)

(72) Inventors: Wan Ti Lin, Hsinchu (TW); Tang-Chi Lin, Hsinchu (TW)

(73) Assignee: GlobalWafers Co., Ltd., Hsinchu (TW)

(21) Appl. No.: 18/809,199

(22) Filed: Aug. 19, 2024

Related U.S. Application Data
(62) Division of application No. 17/860,108, filed on Jul. 8, 2022.

(30) Foreign Application Priority Data
Aug. 9, 2021 (TW) 110129319

(51) Int. Cl. B23Q 3/06; B24B 31/12; B24B 41/06

(52) U.S. Cl. CPC B23Q 3/062; B24B 31/12; B24B 41/06; B23Q 2703/10

(57) ABSTRACT

An ingot edge-polishing machine tool includes a case body, a support base, a first limiting assembly, a second limiting assembly, a polishing assembly, and an ingot fixing assembly. The support base is movably disposed on the case body along a first axis. The first limiting assembly is detachably disposed on the case body. The first limiting assembly is configured to limit a position of the support base on the first axis. The polishing assembly is movably disposed above the support base along the first axis. The second limiting assembly is detachably disposed on the case body. The second limiting assembly is configured to limit a position of the polishing assembly on the first axis. The ingot fixing assembly is rotatably disposed around a second axis and located between the support base and the polishing assembly. The support base is adapted to support an ingot.

### CROSS-REFERENCE TO RELATED APPLICATION

This application is a divisional application and claims the priority benefit of U.S. application Ser. No. 17/860,108, filed on Jul. 8, 2022, which claims the priority benefit of Taiwanese application no. 110129319, filed on Aug. 9, 2021. The entirety of each of the above-mentioned patent applications is hereby incorporated by reference herein and made a part of this specification.

### BACKGROUND

### Technical Field

The disclosure relates to a jig assembly and an edge-polishing machine tool. In particular, the disclosure relates to an ingot jig assembly and an ingot edge-polishing machine tool.

### Description of Related Art

Currently during an edge polishing process of an ingot, an ingot is fixed to a lathe by utilizing a shaft rod that is fixed to an end surface of the ingot by adhesion, so as to perform the edge polishing process. Then, the shaft rod and the end surface of the ingot are separated at the end of the process. However, applying adhesives on and removing adhesives from the shaft rod take relatively more time and procedures. In addition, in the conventional process, center adjustment of the ingot is calibrated with a dial indicator and rubber mallet tapping. Not only are the procedures complicated, but the rubber mallet tapping on the ingot may also cause internal cracks of the ingot.

In addition, if ingots of different dimensions, such as 4-inch, 6-inch, or 8-inch ingots, are used during the general edge polishing process, the procedures for ingot position fixation and center adjustment before polishing may be more time-consuming due to the difference in the dimensions.

### SUMMARY

The disclosure provides an ingot jig assembly, in which an ingot can be fixed simply and conveniently.

The disclosure also provides an ingot edge-polishing machine tool, in which an ingot can be fixed and a position of the ingot can be adjusted rapidly and conveniently.

An ingot jig assembly according to an embodiment of the disclosure includes an end surface clamping jig and an ingot positioning jig. The end surface clamping jig includes two opposite clamping parts. The ingot positioning jig is located below the end surface clamping jig and includes a first base, an adjusting base, and two rollers. The adjusting base is located between the first base and the end surface clamping jig and is movably disposed on the first base along a first axis to be close to or away from the end surface clamping jig. The two rollers are rotatably disposed on the adjusting base.

In an embodiment of the disclosure, when an ingot is disposed on the two rollers of the ingot positioning jig, the two rollers support an annular surface of the ingot. The adjusting base is adapted to move relative to the first base to move the ingot in between the two clamping parts of the end surface clamping jig. The ingot includes two opposite end surfaces. The two clamping parts of the end surface clamping jig abut the two end surfaces of the ingot to fix the ingot.

In an embodiment of the disclosure, a center of the ingot is coaxial with a center of each of the clamping parts.

In an embodiment of the disclosure, the first base includes a main body and a cover fixed to the main body. The ingot positioning jig further includes a first screw rod and a screw rod adjusting knob. The first screw rod extends along the first axis and is fixed to the adjusting base. The screw rod adjusting knob is rotatably disposed between the main body and the cover. The first screw rod is disposed through the cover, the screw rod adjusting knob, and the main body and is threadably engaged with the screw rod adjusting knob.

In an embodiment of the disclosure, an extension direction of the first screw rod passes through a connecting line between two centers of the two clamping parts.

In an embodiment of the disclosure, the ingot positioning jig further includes a guide rod extending along the first axis. The guide rod is disposed through the first base and the adjusting base.

In an embodiment of the disclosure, the first base is movably disposed below the end surface clamping jig along a second axis. The second axis is perpendicular to the first axis.

In an embodiment of the disclosure, the ingot positioning jig further includes an adjusting screw extending along the second axis. The adjusting screw is disposed through the first base, and is adapted to abut an outer shell to adjust a position of the first base relative to the end surface clamping jig on the second axis.

In an embodiment of the disclosure, the ingot jig assembly further includes a driving module and a polishing module. The driving module is disposed on a side of the end surface clamping jig. The polishing module is located between the driving module and the end surface clamping jig and linked to the driving module.

In an embodiment of the disclosure, the ingot jig assembly further includes a moving jig. The moving jig includes a second base and a second screw rod threadably engaged with the second base. The driving module is threadably engaged with the second screw rod and is movably disposed on the second base along with the second screw rod to move the polishing module close to or away from the end surface clamping jig.

In an embodiment of the disclosure, the polishing module includes a diamond grinding disk or a diamond brush.

In an embodiment of the disclosure, the ingot jig assembly further includes an auxiliary positioning jig. The auxiliary positioning jig is movably disposed beside the end surface clamping jig along a second axis and includes two positioning rollers. A connecting line between the two positioning rollers is parallel to the first axis.

In an embodiment of the disclosure, the auxiliary positioning jig includes a positioning rod extending along the second axis. An extension direction of the positioning rod passes through a connecting line of two centers of the two clamping parts.

An ingot edge-polishing machine tool according to an embodiment of the disclosure includes a case body, a support base, a first limiting assembly, a second limiting assembly, a polishing assembly, and an ingot fixing assembly. The support base is movably disposed on the case body along a first axis. The first limiting assembly is detachably disposed on the case body. The first limiting assembly is configured to limit a position of the support base on the first axis. The polishing assembly is movably disposed above the support base along the first axis. The second limiting assembly is detachably disposed on the case body. The second limiting assembly is configured to limit a position of the polishing assembly on the first axis. The ingot fixing assembly is rotatably disposed around a second axis and located between the support base and the polishing assembly. The support base is adapted to support an ingot. The ingot fixing assembly fixes an end surface of the ingot. The polishing assembly is in contact with an edge of the ingot.

In another embodiment of the disclosure, the ingot edge-polishing machine tool further includes a fall prevention assembly located beside the support base. When the support base supports the ingot, the ingot is located between the ingot fixing assembly and the fall prevention assembly, and a height of the fall prevention assembly is greater than half of a distance between the support base and the polishing assembly.

In another embodiment of the disclosure, the fall prevention assembly includes two stop parts. The two stop parts are movably disposed on the case body to be away from or close to each other. A first distance between the two stop parts is less than a diameter of the end surface of the ingot when the two stop parts are close to each other. A second distance between the two stop parts is greater than the diameter of the end surface of the ingot when the two stop parts are away from each other.

In another embodiment of the disclosure, the ingot edge-polishing machine tool further includes an ingot positioning member. The ingot positioning member is movably disposed on the case body along a third axis and located between the support base and the polishing assembly.

In another embodiment of the disclosure, the ingot edge-polishing machine tool further includes a first driving assembly, a second driving assembly, a third driving assembly, and an electrically control assembly. The first driving assembly drives the support base to move along the first axis. The second driving assembly drives the polishing assembly to move along the first axis. The third driving assembly drives the ingot fixing assembly to rotate. The electrically control assembly is disposed on the case body and electrically connected to the first driving assembly, the second driving assembly, and the third driving assembly.

In another embodiment of the disclosure, the ingot fixing assembly includes a suction nozzle and a vacuum pump. The suction nozzle is rotatably disposed around the second axis. The vacuum pump is in communication with the suction nozzle.

In another embodiment of the disclosure, the ingot edge-polishing machine tool further includes a fourth driving assembly. The polishing assembly includes a first polishing element and a second polishing element. A roughness of the first polishing element is different from a roughness of the second polishing element. The fourth driving assembly rotates one of the first polishing element and the second polishing element to a position directly above the support base and rotates the other one away from the position directly above the support base.

In another embodiment of the disclosure, the ingot edge-polishing machine tool further includes a polishing liquid recovering tank, a pump, and a pipeline. The polishing liquid recovering tank is located below the support base. The pump is in communication with the polishing liquid recovering tank. The pipeline is in communication with the pump. The pipeline extends to a position above the polishing assembly.

In another embodiment of the disclosure, the case body includes a first limiting region threaded hole close to the support base and a second limiting region threaded hole close to the polishing assembly. The first limiting assembly includes a first limiting element and a second limiting element. The first limiting element and the second limiting element have different heights. One of the first limiting element and the second limiting element is selectably threadably engaged with the first limiting region threaded hole to limit the position of the support base on the first axis. The second limiting assembly includes a third limiting element and a fourth limiting element. The third limiting element and the fourth limiting element have different heights. One of the third limiting element and the fourth limiting element is selectably threadably engaged with the second limiting region threaded hole to limit the position of the polishing assembly on the first axis.

In another embodiment of the disclosure, the case body includes a first temporary storage region threaded hole and a second temporary storage region threaded hole. The other one of the first limiting element and the second limiting element is threadably engaged with the first temporary storage region threaded hole. The other one of the third limiting element and the fourth limiting element is threadably engaged with the second temporary storage region threaded hole.

Based on the foregoing, in the ingot jig assembly of the disclosure, the two clamping parts of the end surface clamping jig are adapted to clamp the two end surfaces of the ingot. The ingot positioning jig is located below the end surface clamping jig. The adjusting base of the ingot positioning jig is located between the first base and the end surface clamping jig and is movably disposed on the first base along the first axis to be close to or away from the end surface clamping jig. The two rollers of the ingot positioning jig are rotatably disposed on the adjusting base to support the annular surface of the ingot. Therefore, when the ingot is located on the two rollers of the ingot positioning jig, the adjusting base is adapted to move relative to the first base to move the ingot in between the two clamping parts of the end surface clamping jig, and the two clamping parts of the end surface clamping jig abut the two end surfaces of the ingot to fix the ingot. In other words, the ingot positioning jig may be configured to support the ingot to first align the ingot to an appropriate position between the two clamping parts of the end surface clamping jig. Then, the two clamping parts abut the two end surfaces of the ingot so that the two clamping parts of the end surface clamping jig fix the ingot. Subsequently, the ingot may be fixed to a specific device (e.g., a lathe) by utilizing the end surface clamping jig for subsequent procedures (e.g., edge polishing). Compared with the conventional fixing of the shaft rod to the ingot by adhesion, in which applying adhesives and removing adhesives are relatively time-consuming, the ingot jig assembly of the disclosure can be rapidly fixed to or separated from the ingot, which is relatively time-saving and convenient.

In addition, in the ingot edge-polishing machine tool of the disclosure, the first limiting assembly is detachably disposed on the case body and configured to limit the position of the support base on the first axis. Also, the second limiting assembly of the ingot edge-polishing machine tool is detachably disposed on the case body and configured to limit the position of the polishing assembly on the first axis. The support base of the ingot edge-polishing machine tool is movably disposed on the case body along the first axis and is adapted to support the ingot. Moreover, the polishing assembly is movably disposed above the support base along the first axis. Therefore, when the ingot is located on the support base, the ingot may move along with the support base along the first axis to the position limited by the first limiting assembly, and then the polishing assembly moves along the first axis to the position limited by the second limiting assembly to be in contact with the edge of the ingot. Accordingly, the ingot edge-polishing machine tool is adapted for placing ingots of different dimensions. Moreover, the ingot fixing assembly of the ingot edge-polishing machine tool is rotatably disposed around the second axis and located between the support base and the polishing assembly. Subsequently, an end surface of the ingot is fixed by the ingot fixing assembly to ensure that the ingot is stable and still on the first axis. In other words, the positions of ingots of different dimensions relative to the ingot edge-polishing machine tool can be conveniently adjusted and fixed through cooperation of the support base, the polishing assembly, and the ingot fixing assembly, which facilitates operation of subsequent procedures (e.g., edge polishing). The ingot edge-polishing machine tool of the disclosure not only is convenient for adjusting the position of the ingot, but can also be rapidly fixed to or separated from the ingot, which is relatively time-saving.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic perspective view of an ingot jig assembly according to an embodiment of the disclosure.

FIG. 2 is a schematic front view of the ingot jig assembly of FIG. 1 clamping an ingot.

FIG. 3 is a schematic front view of the ingot jig assembly of FIG. 1 clamping another ingot.

FIG. 4 is a schematic perspective view of the ingot jig assembly, a driving module, a polishing module, and a moving jig of FIG. 1.

FIG. 5 is a schematic front view of using an auxiliary positioning jig in FIG. 2.

FIG. 6 is a schematic perspective view of an ingot edge-polishing machine tool according to another embodiment of the disclosure.

FIG. 7 is a schematic perspective view of the ingot, the case body, the support base, and the lower positioning assembly of FIG. 6.

FIG. 8 is a schematic partially enlarged view of the ingot edge-polishing machine tool of FIG. 6.

FIG. 9 is a side view of the ingot edge-polishing machine tool of FIG. 6.

FIG. 10 is a front view of the ingot edge-polishing machine tool of FIG. 6.

FIG. 11A is a schematic view of a first state of a fall prevention assembly of the ingot edge-polishing machine tool of FIG. 6.

FIG. 11B is a schematic view of a second state of the fall prevention assembly of the ingot edge-polishing machine tool of FIG. 6.

FIG. 11C is a schematic view of a third state of the fall prevention assembly of the ingot edge-polishing machine tool of FIG. 6.

### DESCRIPTION OF THE EMBODIMENTS

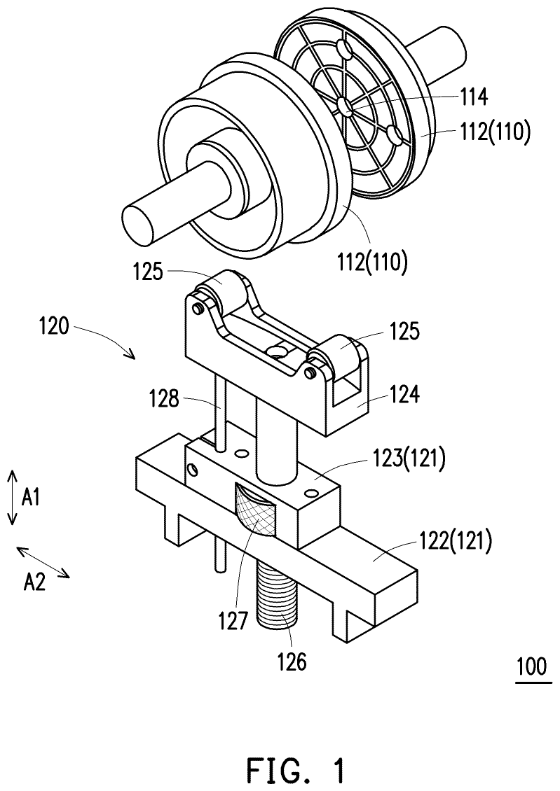

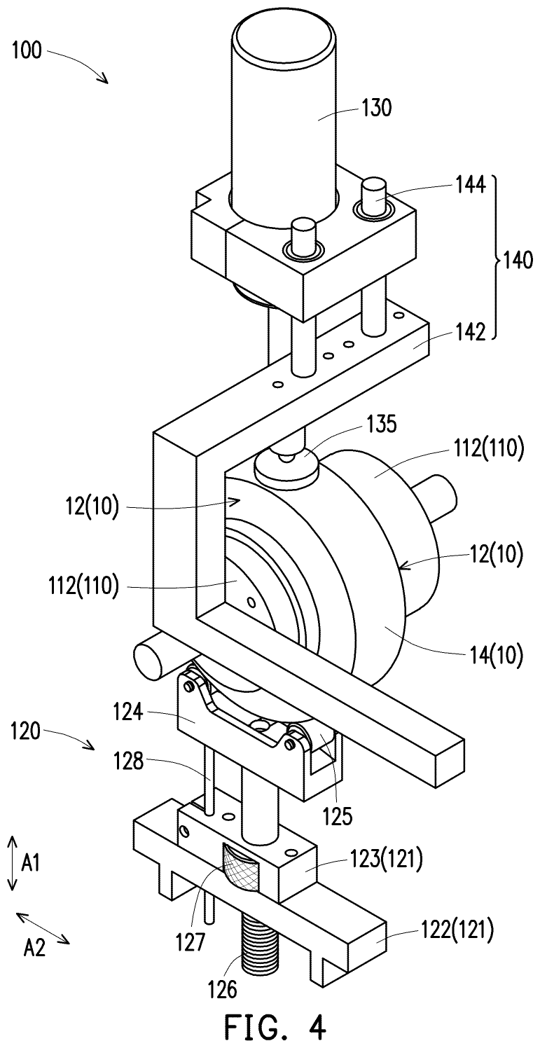

FIG. 1 is a schematic perspective view of an ingot jig assembly according to an embodiment of the disclosure. With reference to FIG. 1, an ingot jig assembly 100 of this embodiment is applicable to an ingot 10 (FIG. 4). The ingot 10 includes two opposite end surfaces 12 (FIG. 4) and an annular surface 14 (FIG. 4) located between the two end surfaces 12.

The ingot jig assembly 100 includes an end surface clamping jig 110 and an ingot positioning jig 120. The end surface clamping jig 110 includes two opposite clamping parts 112. The two clamping parts 112 are adapted to clamp the two end surfaces 12 of the ingot 10.

The ingot positioning jig 120 is located below the end surface clamping jig 110, and includes a first base 121, an adjusting base 124, and two rollers 125. The adjusting base 124 is located between the first base 121 and the end surface clamping jig 110, and is movably disposed on the first base 121 along a first axis A1 to be close to or away from the end surface clamping jig 110.

Specifically, in this embodiment, the ingot positioning jig 120 further includes a first screw rod 126 and a screw rod adjusting knob 127. The first screw rod 126 extends along the first axis A1 and is fixed to the adjusting base 124. The first base 121 includes a main body 122 and a cover 123 fixed to the main body 122. The screw rod adjusting knob 127 is rotatably disposed between the main body 122 and the cover 123. The first screw rod 126 is disposed through the cover 123, the screw rod adjusting knob 127, and the main body 122, and is threadably engaged with the screw rod adjusting knob 127.

In this embodiment, when a user intends to adjust a height of the adjusting base 124, the user may rotate the screw rod adjusting knob 127, and the first screw rod 126 may move up and down relative to the screw rod adjusting knob 127 along the first axis A1. Accordingly, the adjusting base 124 fixed to the first screw rod 126 may move up and down along the first axis A1. Nonetheless, moving the adjusting base 124 up and down along the first axis A1 is not limited thereto.

In addition, in this embodiment, the two rollers 125 are rotatably disposed on the adjusting base 124 and are adapted to support the annular surface 14 of the ingot 10. Since the rollers 125 are rotatable relative to the adjusting base 124, when the rollers 125 support the annular surface 14 of the ingot 10, the rollers 125 are not likely to rub against the annular surface 14 of the ingot 10, achieving protection for the annular surface 14 of the ingot 10.

In addition, in this embodiment, the ingot positioning jig 120 may optionally include a guide rod 128 extending along the first axis A1. The guide rod 128 is disposed through the first base 121 and the adjusting base 124. The guide rod 128 may be configured to move the adjusting base 124 up and down relative to the first base 121 along the first axis A1 with greater precision, ensuring that the adjusting base 124 moves straight up and down.

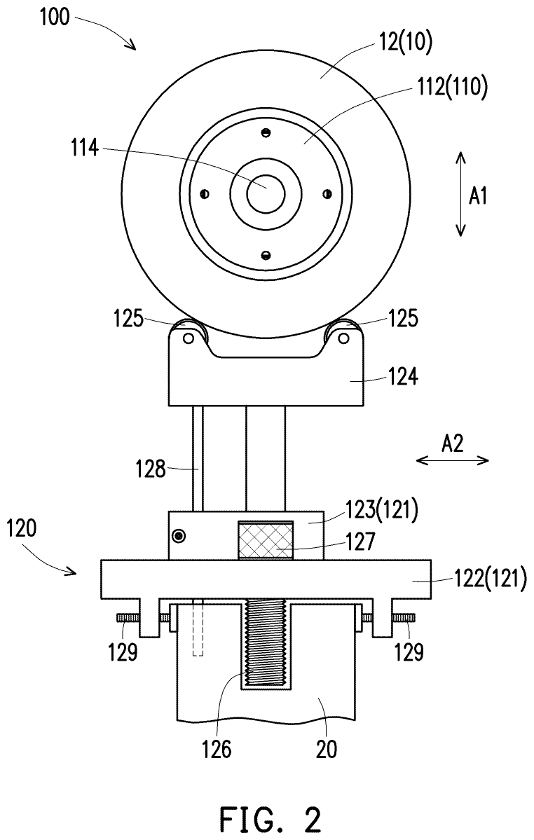

FIG. 2 is a schematic front view of the ingot jig assembly of FIG. 1 clamping an ingot. With reference to FIG. 1 and FIG. 2, when the ingot jig assembly 100 of FIG. 1 is to be used to clamp the ingot 10, the ingot 10 is first placed on the two rollers 125 on the ingot positioning jig 120, and the two clamping parts 112 of the end surface clamping jig 110 are close to the two end surfaces 12 of the ingot 10, but remain loose relative to the two end surfaces 12 of the ingot 10.

Next, the adjusting base 124 is adapted to move relative to the first base 121 to move the ingot 10 in between the two clamping parts 112 of the end surface clamping jig 110, and a center of the adjusting ingot 10 centers 114 of the clamping parts 112 are coaxial.

In this embodiment, the user may move the first screw rod 126 up and down along the first axis A1 by rotating the screw rod adjusting knob 127. Accordingly, the adjusting base 124 fixed to the first screw rod 126 may move up and down along the first axis A1 to align the center of the ingot 10 with the centers 114 of the clamping parts 112 on the first axis A1.

In addition, the first base 121 is movably disposed below the end surface clamping jig 110 along a second axis A2. The second axis A2 is perpendicular to the first axis A1. To be specific, the ingot positioning jig 120 further includes an adjusting screw 129 extending along the second axis A2. The adjusting screw 129 is disposed through the first base 121 and is adapted to abut an outer shell to adjust a position of the first base 121 relative to the end surface clamping jig 110 on the second axis A2. In this embodiment, the outer shell is a rail of a lathe, for example but not limited thereto.

Therefore, the user may move the first base 121 left and right along the second axis A2 by rotating the adjusting screw 129 to align the center of the ingot 10 with the centers 114 of the clamping parts 112 on the second axis A2.

In addition, determining whether the center of the ingot 10 and the centers 114 of the clamping parts 112 are coaxial may include determining by an operator that observes whether an edge of the clamping part 112 and an edge of the end surface 12 of the ingot 10 are kept equidistant.

For example, whether the ingot 10 is aligned may be determined by observing whether a distance between an upper edge of the clamping part 112 and an upper edge of the end surface 12 of the ingot 10 is equal to a distance between a lower edge of the clamping part 112 and a lower edge of the end surface 12 of the ingot 10, and whether a distance between a left edge of the clamping part 112 and a left edge of the end surface 12 of the ingot 10 is equal to a distance between a right edge of the clamping part 112 and a right edge of the end surface 12 of the ingot 10.

After the ingot 10 is aligned, the two clamping parts 112 of the end surface clamping jig 110 abut the two end surfaces 12 of the ingot 10 to fix the ingot 10. Subsequently, a distance between the two clamping parts 112 is reduced, so that the two clamping parts 112 clamp the two end surfaces 12 of the ingot 10. Accordingly, the ingot 10 is fixed.

Next, the ingot positioning jig 120 is lowered by about 1 centimeter and is not in contact with the annular surface 14 of the ingot 10. In this state, the operator may optionally slightly apply an external force on the ingot 10. If the two clamping parts 112 of the ingot 10 are still not found to be loosened relative to the end surface clamping jig 110, it is determined that the ingot 10 is well fixed to the end surface clamping jig 110.

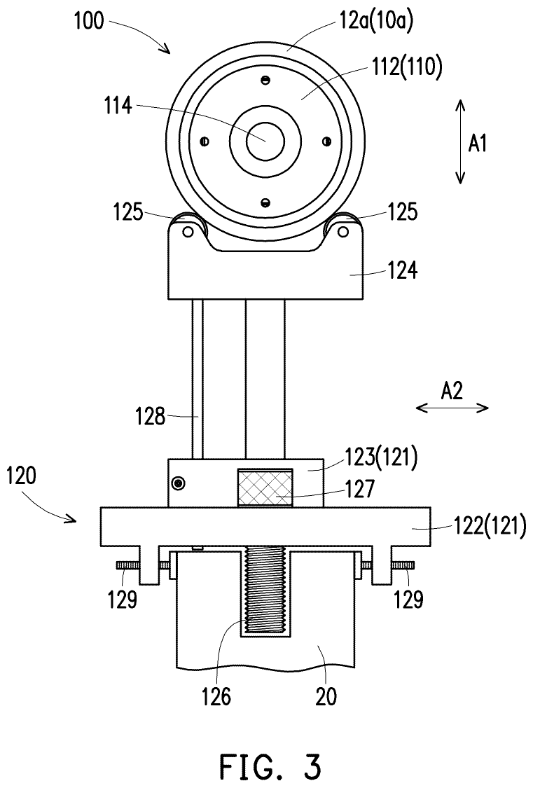

FIG. 3 is a schematic front view of the ingot jig assembly of FIG. 1 clamping another ingot. With reference to FIG. 2 and FIG. 3, in this embodiment, the ingot jig assembly 100 is applicable to the ingot 10 and an ingot 10a of different dimensions. For example, in FIG. 2, the ingot jig assembly 100 may fix the 6-inch ingot 10 to the end surface clamping jig 110. In FIG. 3, the ingot jig assembly 100 may fix the 4-inch ingot 10a to the end surface clamping jig 110. Nonetheless, the dimensions of the ingots 10 and 10a to which the ingot jig assembly 100 is applicable are not limited thereto.

As can be seen from FIG. 3, when the 4-inch ingot 10a is to be fixed to the end surface clamping jig 110, the adjusting base 124 of the ingot positioning jig 120 is raised relative to the first base 121 along the first axis A1 to align a center of an end surface 12a of the ingot 10a supported by the rollers 125 with the centers 114 of the clamping parts 112. After that, the two clamping parts 112 of the end surface clamping jig 110 closely clamp the two end surfaces 12 of the ingot 10a to fix the ingot 10a.

FIG. 4 is a schematic perspective view of the ingot jig assembly, a driving module, a polishing module, and a moving jig of FIG. 1. With reference to FIG. 4, in this embodiment, the ingot jig assembly 100 may be a jig assembly for an edge polishing process, for example. The ingot jig assembly 100 further includes a driving module 130 and a polishing module 135.

The driving module 130 is disposed on a side, such as the upper side, of the end surface clamping jig 110. The driving module 130 is a motor, a hydraulic cylinder, or a pneumatic cylinder, for example. Nonetheless, the type of the driving module 130 is not limited thereto.

The polishing module 135 is located between the driving module 130 and the end surface clamping jig 110, and is linked with the driving module 130. The polishing module 135 is adapted to polish the annular surface 14 of the ingot 10 clamped by the end surface clamping jig 110. During polishing, the end surface clamping jig 110 may be fixed to a lathe or other rotating structures, the end surface clamping jig 110 drives the ingot 10 to rotate together, and the polishing module 135 abuts the annular surface 14 of the ingot 10 to polish the annular surface 14. In this embodiment, the polishing module 135 includes a diamond grinding disk. In other embodiments, the polishing module 135 may also include a diamond brush.

In addition, the ingot jig assembly 100 further includes a moving jig 140. The moving jig 140 includes a second base 142 and a second screw rod 144 threadably engaged with the second base 142. The driving module 130 is threadably engaged with the second screw rod 144 and is movably disposed on the second base 142 along the first axis A1 along with the second screw rod 144. In conjunction, the driving module 130 and the polishing module 135 are moved up and down along the first axis A1, so that the polishing module 135 is close to or away from the end surface clamping jig 110. Accordingly, the polishing module 135 may be close to or away from the annular surface 14 of the ingot 10.

During processing of the ingots 10 with different outer diameters, in the ingot jig assembly 100, it is possible to adjust only a position of the second screw rod 144 relative to the second base 142 to accordingly adjust a height of the polishing module 135, so that the polishing module 135 is in contact with the annular surface 14 of the ingot 10. Moreover, since the position of the second screw rod 144 relative to the second base 142 is adjustable, the height of the polishing module 135 may also be adjusted in conjunction. When the annular surface 14 of the ingot 10 has a flat (non-arc) portion that does not need to be processed, the polishing module 135 may be disposed at a position that can avoid the flat portion. In other words, the polishing module 135 processes only the arc portion and does not process the flat portion of the annular surface 14 of the ingot 10, achieving improvement to rounding.

In other embodiments, the moving jig 140 may also be omitted. For example, in the case where the annular surface 14 of the ingot 10 is a completely arc surface, the ingot jig assembly 100 without the moving jig 140 can provide stable pressure for processing the annular surface 14 of the ingot 10.

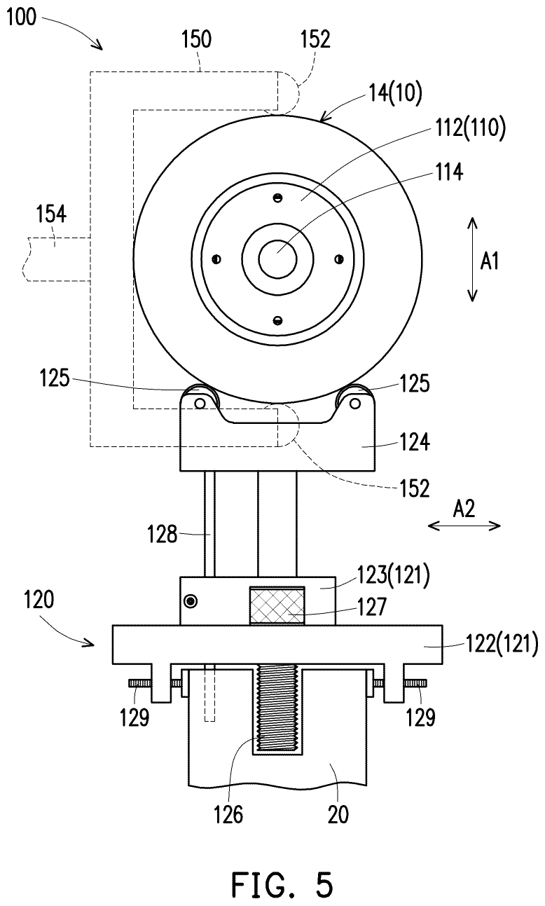

Whether the center of the ingot 10 and the centers 114 of the clamping parts 112 are coaxial may also be determined by the following. FIG. 5 is a schematic front view of using an auxiliary positioning jig in FIG. 2. With reference to FIG. 5, in this embodiment, when the ingot 10 is fixed by the end surface clamping jig 110, as can be seen from FIG. 5 (a front view), an extension direction of the first screw rod 126 passes through the centers 114 of the clamping parts 112. When viewed in FIG. 4 (a perspective view), the extension direction of the first screw rod 126 passes through a connecting line between the two centers of the two clamping parts 112. The above means that the ingot 10 is well aligned on the second axis A2.

In addition, in this embodiment, the ingot jig assembly 100 further includes an auxiliary positioning jig 150. The auxiliary positioning jig 150 is movably disposed beside the end surface clamping jig 110 along the second axis A2 and includes two positioning rollers 152. A connecting line between the two positioning rollers 152 is parallel to the first axis A1. A distance between the two positioning rollers 152 corresponds to the dimension of the ingot 10, and the two positioning rollers 152 are adapted to abut the upper and lower ends of the annular surface 14 of the ingot 10. Therefore, when alignment is to be performed, the two positioning rollers 152 of the auxiliary positioning jig 150 are in contact with the upper and lower ends of the annular surface 14 of the ingot 10.

In addition, the auxiliary positioning jig 150 includes a positioning rod 154 extending along the second axis A2. When the ingot 10 is fixed by the end surface clamping jig 110, as can be seen from FIG. 5 (a front view), an extension direction of the positioning rod 154 passes through the centers 114 of the clamping parts 112. In other words, in the perspective view, the extension direction of the positioning rod 154 passes through the connecting line between the two centers 114 of the two clamping parts 112. The above means that the ingot 10 is well aligned on the first axis A1.

In other embodiments, the operator may also determine whether the center of the ingot 10 and the centers 114 of the clamping parts 112 are coaxial in other manners.

In the conventional process, center adjustment of the ingot is calibrated with a dial indicator and rubber mallet tapping. Not only are the procedures complicated, but the rubber mallet tapping on the ingot may also cause internal cracks of the ingot. In the ingot jig assembly 100 of this embodiment, calibration may be completed by measuring whether the distances between the upper, lower, left, and right edges of the clamping part 112 and the upper, lower, left, and right edges of the end surface 12 of the ingot 10 are the same, or by checking whether the extension direction of the first screw rod 126 and the extension direction of the positioning rod 154 pass through the centers 114 of the clamping parts 112. In the ingot jig assembly 100 of this embodiment, since it is not required to tap on the ingot 10 to position the ingot 10, internal cracks of the ingot 10 during alignment can be effectively prevented.

In addition, in the ingot jig assembly 100 of this embodiment, instead of adhering a shaft rod to the ingot 10, the ingot 10 is clamped by the end surface clamping jig 110. Therefore, the overall time for fixing the ingot 10 can be reduced by as much as 6 hours. In the ingot jig assembly 100 of this embodiment, the processing time of fixing and polishing the ingot 10 is about 5 minutes, which is relatively short.

Moreover, according to tests of polishing with the end surface clamping jig 110 of this embodiment clamping the SiC ingot 10, if the polishing module 135 is a diamond grinding disk at a rotation speed of 6,000 rpm, the Ra of the polished annular surface 14 of the ingot 10 is reduced from 0.6 micrometer (μm) to 0.25 μm, presenting a relatively good performance. If the polishing module 135 is a diamond brush, the average Ra of the polished annular surface 14 of the ingot 10 is about 0.36 μm, also presenting a relatively good performance. Furthermore, the surface luster of the annular surface 14 of the ingot 10 is changed from dark to bright, and the test results meet the current requirements.

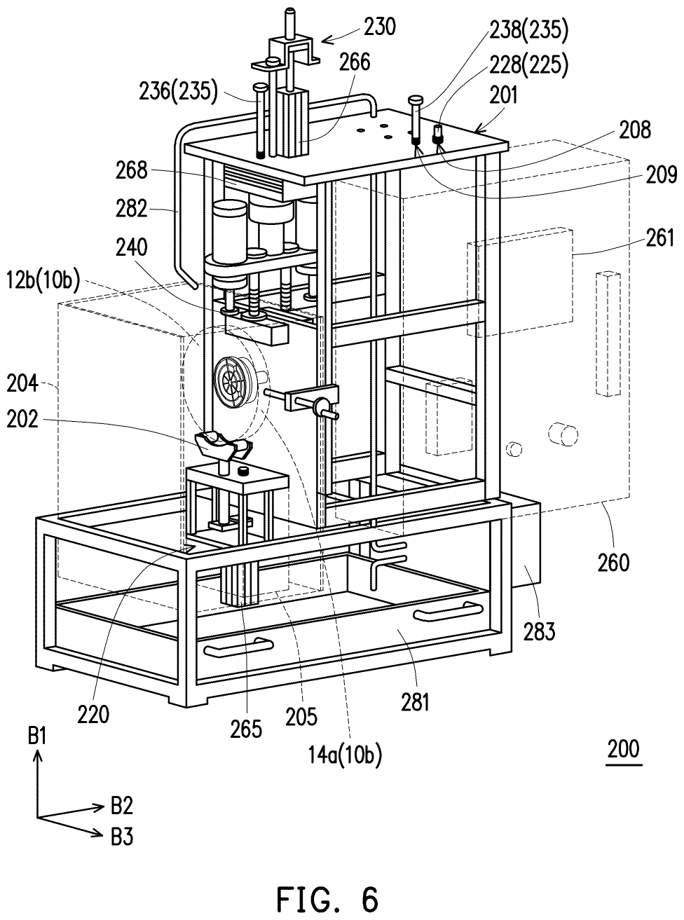

FIG. 6 is a schematic perspective view of an ingot edge-polishing machine tool according to another embodiment of the disclosure. To clearly present the configuration of the internal structure in FIG. 6, the fall prevention assembly is not shown, and the first box body, second box body, ingot, and electrically control assembly are drawn with broken lines. With reference to FIG. 6, an ingot edge-polishing machine tool 200 of this embodiment is applicable to an ingot 10b. The ingot 10b includes two opposite end surfaces 12b and an annular surface 14a located between the two end surfaces 12b. The ingot edge-polishing machine tool 200 is adapted to polish the annular surface 14a of the ingot 10b. A diameter of the ingot 10b is 4 inches, 6 inches, or 8 inches, for example, but the dimension of the ingot 10b is not limited thereto.

The ingot edge-polishing machine tool 200 includes a case body 201, a support base 202, and a lower positioning assembly 220. The support base 202 is adapted to support the ingot 10b. The support base 202 is located above the lower positioning assembly 220, and is movably disposed on the case body 201 along a first axis B1.

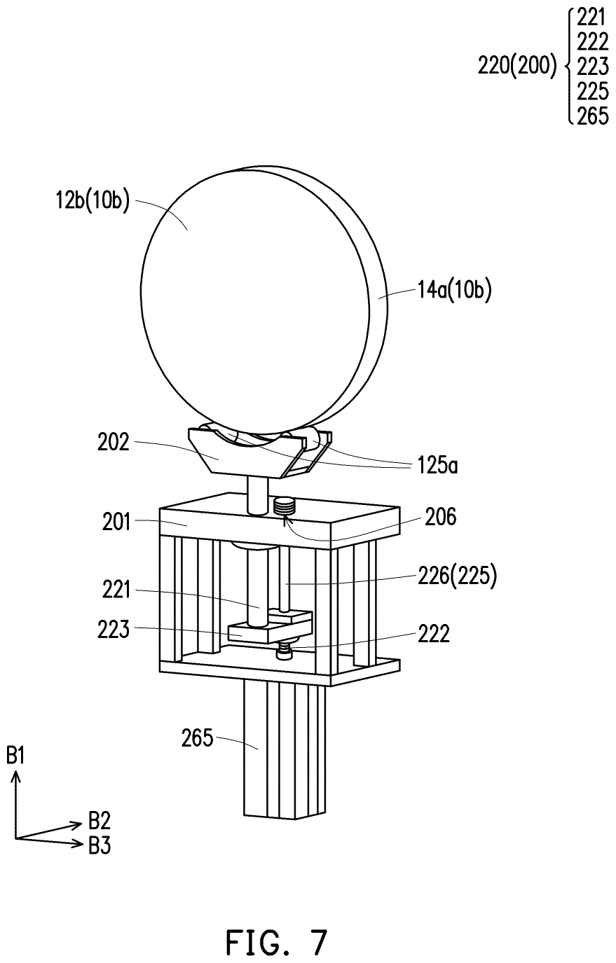

FIG. 7 is a schematic perspective view of the ingot, the case body, the support base, and the lower positioning assembly of FIG. 6. With reference to FIG. 7, the lower positioning assembly 220 includes a moving rod member 221, a first output shaft member 222, a first connecting member 223, and a first driving assembly 265. The first driving assembly 265 is disposed on the case body 201 and connected to the first output shaft member 222. The first output shaft member 222 is connected to one end of the moving rod member 221 through the first connecting member 223, and the other end of the moving rod member 221 is disposed through the case body 201 and connected to the support base 202. The moving rod member 221 is parallel to the first output shaft member 222. The first connecting member 223 is located below the support base 202 and above the first driving assembly 265.

When an operator intends to change a height of the support base 202, the operator may drive the support base 202 to move along the first axis B1 by the first driving assembly 265. Specifically, when the first driving assembly 265 drives the first output shaft member 222 to move along the first axis B1, since the first output shaft member 222 is connected with the moving rod member 221 through the first connecting member 223, the moving rod member 221 is movable along the first axis B1 along with the first output shaft member 222. Therefore, the support base 202 connected to the moving rod member 221 also moves along the first axis B1 at the same time, and the height of the support base 202 may be adjusted accordingly.

In this embodiment, the first driving assembly 265 is a pneumatic cylinder, but the type of the first driving assembly 265 is not limited thereto.

In addition, the support base 202 of this embodiment has two rollers 125a rotatable relative to the support base 202. When the rollers 125a support the annular surface 14a of the ingot 10b, the rollers 125a are not likely to rub against the annular surface 14a of the ingot 10b, achieving protection for the annular surface 14a of the ingot 10b.

In this embodiment, the lower positioning assembly 220 further includes a first limiting assembly 225. The first limiting assembly 225 is located above the first connecting member 223 and is detachably disposed on the case body 201. When the support base 202 is raised to a certain height along the first axis B1, the first connecting member 223 is in contact with and abuts the first limiting assembly 225 to prevent the moving rod member 221 from being raised further, and the support base 202 stops moving accordingly. In other words, the first limiting assembly 225 may limit a position of the support base 202 on the first axis B1, so that the ingot 10b stays at a predetermined height.

In addition, the case body 201 includes a first limiting region threaded hole 206 close to the support base 202. The first limiting region threaded hole 206 is configured to be threadably engaged with the first limiting assembly 225. In this embodiment, the first limiting assembly 225 includes a first limiting element 226 and a second limiting element 228 (FIG. 6). The first limiting element 226 and the second limiting element 228 have different heights. One of the first limiting element 226 and the second limiting element 228 is selectably threadably engaged with the first limiting region threaded hole 206 to limit the position of the support base 202 on the first axis B1.

In other words, the operator may change a predetermined position of the support base 202 on the first axis B1 by replacing the first limiting assembly 225 to match the ingots 10b of different dimensions.

Moreover, there may be slight differences in the actual sizes between ingots 10b of the same dimension. Therefore, after the first limiting assembly 225 is threadably engaged with the first limiting region threaded hole 206 (FIG. 7), a user may manually fine-tune a height of the first limiting assembly 225 to achieve the ideal height of the ingot 10b on the first axis B1.

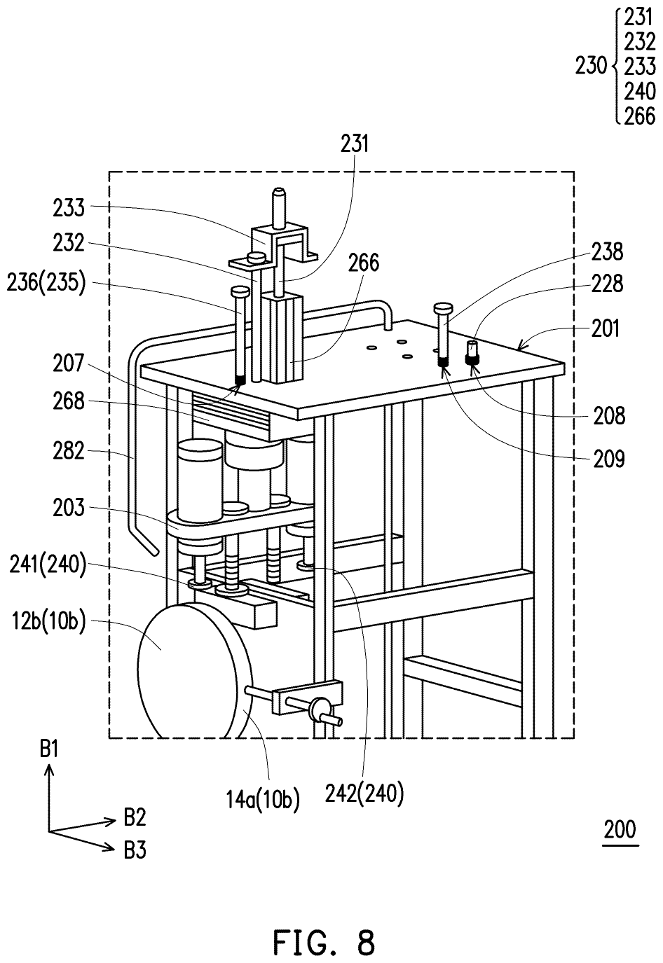

FIG. 8 is a schematic partially enlarged view of the ingot edge-polishing machine tool of FIG. 6. The first box body and electrically control assembly are not shown to clearly present the configuration of the internal structure in FIG. 8. With reference to FIG. 8, in this embodiment, the ingot edge-polishing machine tool 200 further includes a polishing assembly 240 and an upper positioning assembly 230. The polishing assembly 240 is disposed through a frame body 203 and is movably disposed above the support base 202 along the first axis B1 to polish the annular surface 14a of the ingot 10b supported by the support base 202.

The polishing assembly 240 may be a diamond brush or a diamond grinding disk, but the type of the polishing assembly 240 is not limited thereto.

The upper positioning assembly 230 includes a second driving assembly 266, a second output shaft member 231, a third output shaft member 232, and a second connecting member 233. The second driving assembly 266 is disposed on the case body 201, located above the polishing assembly 240, and connected to the second output shaft member 231. The second output shaft member 231 is connected to the third output shaft member 232 through the second connecting member 233. The third output shaft member 232 is parallel to the second output shaft member 231. Moreover, the third output shaft member 232 is disposed through the case body 201 and connected to the frame body 203.

When the operator intends to change a height of the polishing assembly 240, the operator may drive the polishing assembly 240 to move along the first axis B1 by the second driving assembly 266 in a similar process of adjusting the height of the support base 202.

Specifically, when the second driving assembly 266 drives the second output shaft member 231 to move along the first axis B1, since the second output shaft member 231 is connected with the third output shaft member 232 through the second connecting member 233, the third output shaft member 232 is movable along the first axis B1 along with the second output shaft member 231. Therefore, the frame body 203 connected to the third output shaft member 232 and the polishing assembly 240 on the frame body 203 also move along the first axis B1 at the same time, and the height of the polishing assembly 240 may be adjusted accordingly.

The second driving assembly 266 of this embodiment is a pneumatic cylinder, but the type of the second driving assembly 266 is not limited thereto.

In this embodiment, the ingot edge-polishing machine tool 200 further includes a second limiting assembly 235. The second limiting assembly 235 is located below the second connecting member 233 and is detachably disposed on the case body 201. When the polishing assembly 240 is lowered to a certain height along the first axis B1, the second connecting member 233 is in contact with and abuts the second limiting assembly 235 to prevent the third output shaft member 232 from being lowered further, and the polishing assembly 240 stops moving accordingly. In other words, the second limiting assembly 235 limits a position of the polishing assembly 240 on the first axis B1, so that the polishing assembly 240 stays at a predetermined height.

In addition, the case body 201 further includes a second limiting region threaded hole 207 close to the polishing assembly 240. The second limiting region threaded hole 207 is configured to be threadably engaged with the second limiting assembly 235. In this embodiment, the second limiting assembly 235 includes a third limiting element 236 and a fourth limiting element 238. The third limiting element 236 and the fourth limiting element 238 have different heights. One of the third limiting element 236 and the fourth limiting element 238 is selectably threadably engaged with the second limiting region threaded hole 207 to limit the position of the polishing assembly 240 on the first axis B1.

In other words, the operator may change a predetermined position of the polishing assembly 240 on the first axis B1 by replacing the second limiting assembly 235, so that the polishing assembly 240 can smoothly be in contact with the edges of the ingot 10b of different dimensions.

Moreover, there may be slight differences in the actual sizes between ingots 10b of the same dimension. Therefore, after the second limiting assembly 235 is threadably engaged with the second limiting region threaded hole 207, the user may manually fine-tune a height of the second limiting assembly 235, so that the polishing assembly 240 is appropriately in contact with the annular surface 14a of the ingot 10b.

In this embodiment, the polishing assembly 240 includes a first polishing element 241 and a second polishing element 242. A roughness of the first polishing element 241 is different from a roughness of the second polishing element 242. The first polishing element 241 and the second polishing element 242 are arranged in parallel and located on two sides of the frame body 203 to polish the ingot 10b to different extents.

Specifically, the ingot edge-polishing machine tool 200 further includes a fourth driving assembly 268 disposed on the case body 201, located between the second driving assembly 266 and the polishing assembly 240, and connected to the third output shaft member 232. The fourth driving assembly 268 is a rotary pneumatic cylinder, for example. The fourth driving assembly 268 rotates around the first axis and is configured to rotate one of the first polishing element 241 and the second polishing element 242 to a position directly above the support base 202 and rotate the other one away from the position directly above the support base 202. Accordingly, the ingot 10b may be polished by different polishing assemblies 240. For example, the ingot 10b is first preliminarily polished by the polishing assembly 240 with a greater roughness, and then finely polished by the polishing assembly 240 with a less roughness. Nonetheless, the operator may also polish the ingot 10b with only one type of polishing assembly 240.

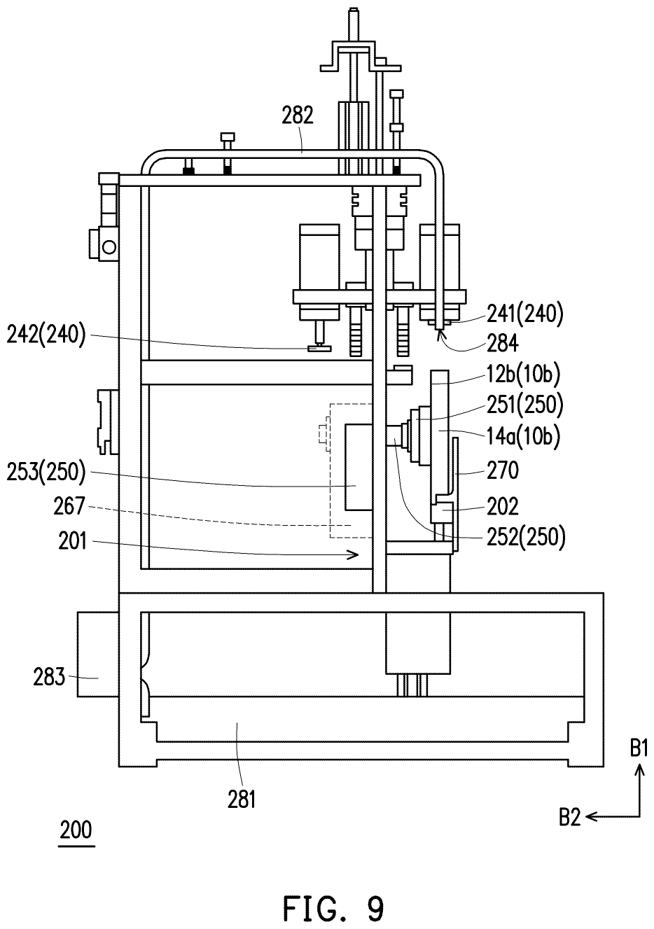

FIG. 9 is a side view of the ingot edge-polishing machine tool of FIG. 6. To clearly present the configuration of the internal structure in FIG. 9, the first box body and electrically control assembly are not shown, and the third driving assembly is drawn with broken lines. The ingot edge-polishing machine tool 200 further includes an ingot fixing assembly 250. The ingot fixing assembly 250 is rotatably disposed around a second axis B2 and located between the support base 202 and the polishing assembly 240, and is adapted to fix one of the end surfaces 12b of the ingot 10b.

To be specific, the ingot fixing assembly 250 includes a suction nozzle 251 rotatably disposed around the second axis B2, a hollow shaft 252, and a vacuum pump 253. The vacuum pump 253 is disposed on the case body 201 and is in communication with the suction nozzle 251 through the hollow shaft 252. When the ingot 10b is to be fixed, the ingot 10b is first placed on the support base 202 and the end surfaces 12b of the ingot 10b are close to and in contact with the suction nozzle 251, so that a peripheral edge of the end surface 12b and a peripheral edge of the suction nozzle 251 are in close contact. Then, gases within the space between the end surface 12b of the ingot 10b and the suction nozzle 251 are removed by the operation of the vacuum pump 253. Accordingly, the ingot 10b is effectively fixed to, instead of falling off, the ingot fixing assembly 250.

The ingot edge-polishing machine tool 200 further includes a third driving assembly 267. The third driving assembly 267 is disposed on the case body 201, and is configured to drive the ingot fixing assembly 250 (i.e., the hollow shaft 252 and the suction nozzle 251) to rotate around the second axis B2. Specifically, during edge polishing, the ingot 10b is fixed to the ingot fixing assembly 250, and the polishing assembly 240 abuts the annular surface 14a of the ingot 10b. When the third driving assembly 267 is activated, the ingot 10b rotates along with the ingot fixing assembly 250, and the polishing assembly 240 polishes the annular surface 14a accordingly.

The third driving assembly 267 of this embodiment is a motor, but the type of the third driving assembly 267 is not limited thereto.

In addition, the ingot fixing assembly 250 of this embodiment also has two suction modes: a weak suction mode and a strong suction mode. When the ingot fixing assembly 250 is in the weak suction mode, the operator may apply a slight external force on the ingot 10b on the suction nozzle 251 to move the ingot 10b accordingly, which is applicable to the positioning adjustment of the ingot 10b before polishing.

When the ingot fixing assembly 250 is in the strong suction mode, the suction nozzle 251 is more strongly adsorbed to the ingot 10b to prevent the ingot 10b from being easily moved by an external force to ensure that the ingot 10b is stable and still during edge polishing.

In this embodiment, the ingot edge-polishing machine tool 200 further includes a polishing liquid recovering tank 281, a pipeline 282, and a pump 283 to recover a polishing liquid used during edge polishing. The polishing liquid recovering tank 281 is movably disposed below the case body 201 and is configured to receive the used polishing liquid. The pipeline 282 may be a flexible pipe, a rigid pipe, or a combination of flexible and rigid pipes, for example. One end of the pipeline 282 is adapted to be in communication with the pump 283 and the other end has an opening 284. The pipeline 282 extends to a position above the polishing assembly 240 from the pump 283.

During edge polishing, the polishing liquid flows to the ingot 10b and is recovered in the polishing liquid recovering tank 281. At this time, the pump 283 in communication with the polishing liquid recovering tank 281 and the pipeline 282 is operated. The used polishing liquid in the polishing liquid recovering tank 281 is pumped and conveyed to the pipeline 282 to flow through the pipeline 282 from the opening 284 above the ingot 10b to the ingot 10b again, achieving reuse of the polishing liquid, and reducing the consumption of the polishing liquid accordingly.

When the polishing liquid in the polishing liquid recovering tank 281 can no longer be used, the polishing liquid recovering tank 281 may be moved away from the ingot edge-polishing machine tool 200 to clean the polishing liquid off. After being cleaned, the polishing liquid recovering tank may be placed back below the support base 202 again for use during the next edge polishing.

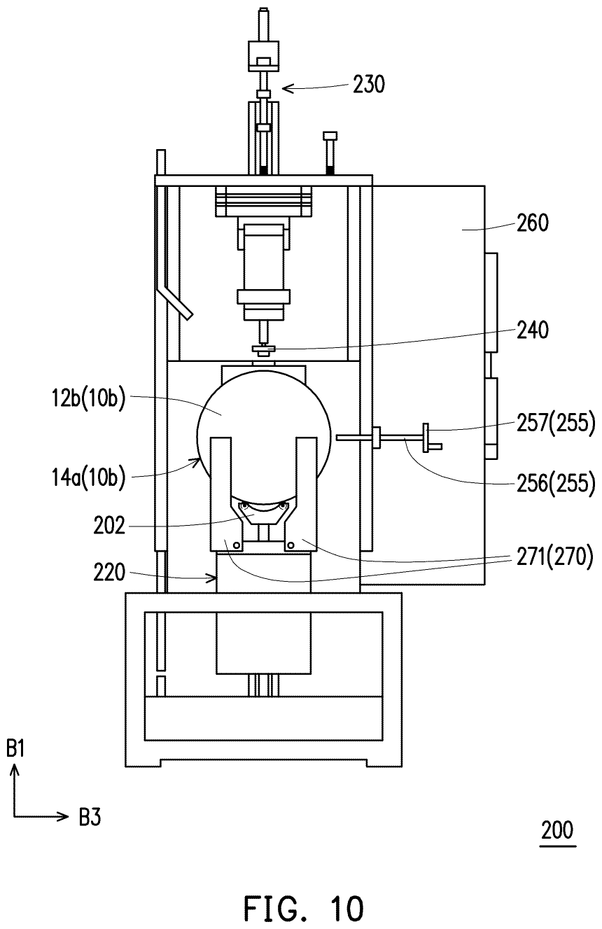

FIG. 10 is a front view of the ingot edge-polishing machine tool of FIG. 6. The first box body is not shown to clearly present the configuration of the internal structure in FIG. 10. In this embodiment, the ingot edge-polishing machine tool 200 further includes an ingot positioning member 255. The ingot positioning member 255 has an adjusting push rod 256 and an adjusting wheel 257, is movably disposed on the case body 201 along a third axis B3 and located between the support base 202 and the polishing assembly 240, and is adapted to adjust a position of the ingot 10b on the third axis B3.

By rotating the adjusting wheel 257, the user may move the adjusting push rod 256 along the third axis B3 to be close to or away from the ingot 10b on the suction nozzle 251 (FIG. 9).

When center adjustment is to be performed on the ingot 10b, the ingot 10b is first fixed to the suction nozzle 251 (FIG. 9) in the weak suction mode, and the third driving assembly 267 is activated to rotate the ingot 10b around the second axis B2 at a slow speed (e.g., at a rotation speed of less than 100 rpm). Next, the adjusting wheel 257 is operated to make the adjusting push rod 256 close to the annular surface 14a of the ingot 10b along the third axis B3. When the ingot 10b is in touch with the adjusting push rod 256, if the ingot 10b is deviated from a center of the suction nozzle 251, the deviated side of the ingot 10b may accordingly be pushed back to the center of the suction nozzle 251 by the adjusting push rod 256. As a result, a center of the ingot 10b and the center of the suction nozzle 251 are coaxial.

Theoretically, the center of the ingot 10b and the center of the suction nozzle 251 (FIG. 9) are coaxial. However, the actual position of the ingot 10b placed on the support base 202 may be deviated from the center, in other words, the center of the ingot 10b and the center of the suction nozzle 251 are not in a coaxial position, so that the position of the ingot 10b is required to be adjusted. The center adjustment of the ingot 10b may depend on the extent of deviation from the center.

For example, the user may make the adjusting push rod 256 close to the annular surface 14a of the ingot 10b. If the actual position of the ingot 10b placed on the support base 202 is deviated from (e.g., to the left of or to the right of) the theoretical position of the ingot 10b on the support base 202, during one rotation of the ingot 10b located on the support base 202, the adjusting push rod 256 may be in contact with the protruding portion of the annular surface 14a of the ingot 10b due to the positional deviation, and push the portion in contact toward another direction. Next, after the adjusting push rod 256 is slightly pushed forward, during another rotation of the ingot 10b located on the support base 202, the portion of the annular surface 14a of the ingot 10b protruding from the theoretical position is further pushed in another direction by the adjusting push rod 256.

If the ingot 10b is still deviated, the adjusting push rod 256 is further slightly pushed forward, and the operations are performed in alternation, to gradually align the position of the ingot 10b on the support base 202 until the center of the ingot 10b and the center of the suction nozzle 251 (FIG. 9) are coaxial. In this embodiment, the operator may determine that the center of the ingot 10b and the center of the suction nozzle 251 are coaxial by utilizing measurement by a gauge.

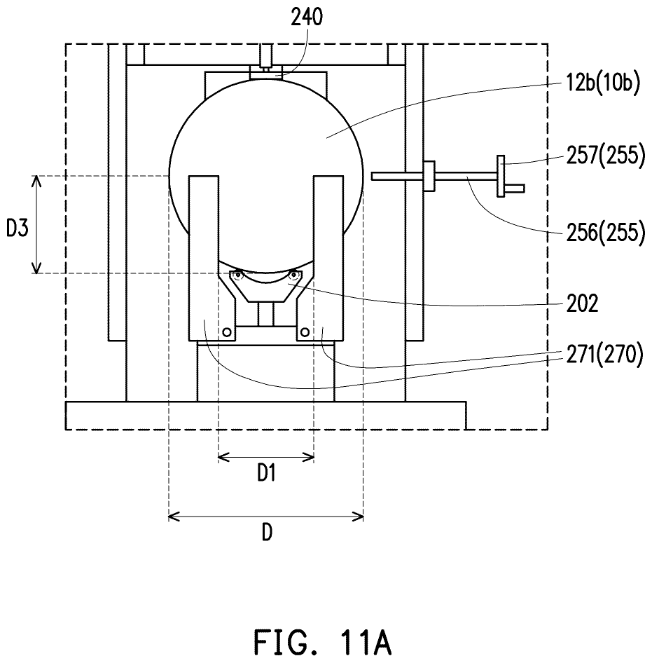

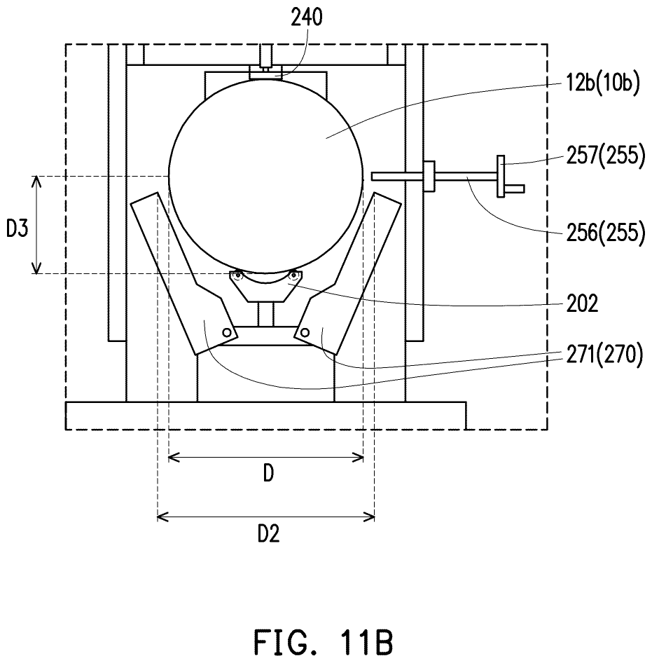

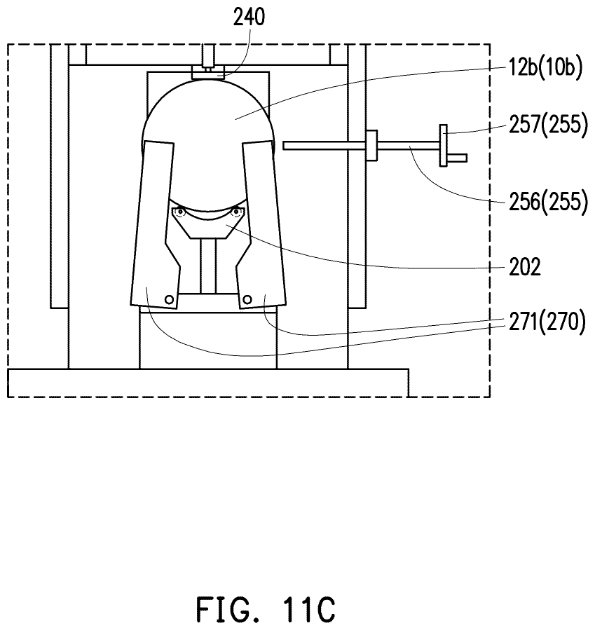

FIG. 11A is a schematic view of a first state of a fall prevention assembly of the ingot edge-polishing machine tool of FIG. 6. FIG. 11B is a schematic view of a second state of the fall prevention assembly of the ingot edge-polishing machine tool of FIG. 6. FIG. 11C is a schematic view of a third state of the fall prevention assembly of the ingot edge-polishing machine tool of FIG. 6. The first box body and electrically control assembly are not shown to clearly present the configuration of the internal structure in FIG. 11A to 11C. With reference to FIG. 9 and FIG. 11A together, in this embodiment, the ingot edge-polishing machine tool 200 further includes a fall prevention assembly 270. The fall prevention assembly 270 is located beside the support base 202. The ingot 10b is located between the ingot fixing assembly 250 and the fall prevention assembly 270.

When the support base 202 supports the ingot 10b and the polishing assembly 240 is in contact with the ingot 10b, a height of the fall prevention assembly 270 is greater than half of a distance (a third distance D3) between the support base 202 and the polishing assembly 240. Accordingly, when the ingot 10b is detached from the ingot fixing assembly 250 due to an unexpected situation (e.g., a power failure), the fall prevention assembly 270 can prevent the ingot 10b from being damaged due to leaning forward and falling off the support base 202.

With reference to FIG. 11A and FIG. 11B, the fall prevention assembly 270 of this embodiment includes two stop parts 271. The two stop parts 271 are movably disposed on the case body 201 to be away from or close to each other. When the two stop parts 271 are close to each other, a first distance D1 between the two stop parts 271 is less than a diameter D of the end surface 12b of the ingot 10b to prevent the ingot 10b from falling off the support base 202.

When the two stop parts 271 are away from each other, a second distance D2 between the two stop parts 271 is greater than the diameter D of the end surface 12b of the ingot 10b, and the operator can smoothly take out or place the ingot 10b from the front of the support base 202 without being blocked by the two stop parts 271, which is relatively convenient in operation.

In addition, with reference to FIG. 11C, the distance between the two stop parts 271 may be flexibly adjusted according to the dimension of the ingot 10b. For example, when the dimension of the ingot 10b is relatively small, the two stop parts 271 may be even closer to each other to prevent the ingot 10b of a relatively small dimension from falling from between the two stop parts 271.

With reference back to FIG. 6, in this embodiment, the ingot edge-polishing machine tool 200 is further used with automated edge polishing, in which automated polishing operations can be performed on the ingots 10b of different dimensions. To be specific, the ingot edge-polishing machine tool 200 further includes an electrically control assembly 260 disposed on the case body 201. The electrically control assembly 260 is electrically connected to the first driving assembly 265, the second driving assembly 266, the third driving assembly 267 (FIG. 9), and the fourth driving assembly 268, and controls the operations of the first driving assembly 265, the second driving assembly 266, the third driving assembly 267 (FIG. 9), and the fourth driving assembly 268. After the ingot 10b is positioned on the ingot edge-polishing machine tool 200, through a touch screen 261 on the electrically control assembly 260, the user may set the time length and number of times of polishing the ingot 10b by the polishing assembly 240, and the type of the polishing assembly 240 used for polishing. For example, the settings are: at an ingot rotation speed of 2,625 rpm, the ingot 10b was first polished three times with the first polishing element 241 (FIG. 8) for 180 seconds each time, and the ingot 10b was then polished three times with the second polishing element 242 (FIG. 8) for 180 seconds each time. Nonetheless, the settings of polishing are not limited thereto.

In the conventional process, the edge polishing process of an ingot is performed manually and requires frequent operations and attention by practitioners. In the ingot edge-polishing machine tool 200 of this embodiment, automated edge polishing is used, which not only saves manpower, but also reduces the ingot fragmentation rate from 30% to 5% according to experimental tests, effectively improving the yield and reducing the cost.

In this embodiment, the case body 201 further includes at least one first temporary storage region threaded hole 208 and at least one second temporary storage region threaded hole 209. When one of the first limiting element 226 (FIG. 7) and the second limiting element 228 is threadably engaged with the first limiting region threaded hole 206 (FIG. 7), the other one of the first limiting element 226 and the second limiting element 228 may be threadably engaged with the first temporary storage region threaded hole 208 to temporarily place the other one of the first limiting element 226 and the second limiting element 228. Similarly, when one of the third limiting element 236 and the fourth limiting element 238 is threadably engaged with the second limiting region threaded hole 207 (FIG. 8), the other one of the third limiting element 236 and the fourth limiting element 238 may be threadably engaged with the second temporary storage region threaded hole 209 to temporarily place the other one of the third limiting element 236 and the fourth limiting element 238.

In this embodiment, the number of the first temporary storage region threaded hole 208 and the number of the second temporary storage region threaded hole 209 are each plural, but not limited thereto.

In addition, in this embodiment, the ingot edge-polishing machine tool 200 further has a first box body 204 and a second box body 205 to limit the range of slag spattering during polishing.

In the conventional process, center adjustment of the ingot is calibrated with a dial indicator and rubber mallet tapping. Not only are the procedures complicated, but the rubber mallet tapping on the ingot may also cause internal cracks of the ingot. In the ingot edge-polishing machine tool 200 of this embodiment, the ingot 10b is positioned in the up-down direction through the lower positioning assembly 220 and the upper positioning assembly 230, and the ingot 10b is positioned in the left-right direction by utilizing the ingot positioning member 255, achieving rapid center adjustment. In the ingot edge-polishing machine tool 200 of this embodiment, since it is not required to tap on the ingot 10b to position the ingot 10b, internal cracks of the ingot during alignment can be effectively prevented.

In addition, in the ingot edge-polishing machine tool 200 of this embodiment, the ingot 10b is fixed by the suction nozzle 251 of the ingot fixing assembly 250, and no adhesive is not required for adhering, saving the processes of applying adhesives and removing adhesives, which is relatively convenient and rapid.

In summary of the foregoing, in the ingot jig assembly of the disclosure, the two clamping parts of the end surface clamping jig are adapted to clamp the two end surfaces of the ingot. The ingot positioning jig is located below the end surface clamping jig. The adjusting base of the ingot positioning jig is located between the first base and the end surface clamping jig and is movably disposed on the first base along the first axis to be close to or away from the end surface clamping jig. The two rollers of the ingot positioning jig are rotatably disposed on the adjusting base to support the annular surface of the ingot. Therefore, when the ingot is located on the two rollers of the ingot positioning jig, the adjusting base is adapted to move relative to the first base to move the ingot in between the two clamping parts of the end surface clamping jig, and the two clamping parts of the end surface clamping jig abut the two end surfaces of the ingot to fix the ingot. In other words, the ingot positioning jig may be configured to support the ingot to first align the ingot to an appropriate position between the two clamping parts of the end surface clamping jig. Then, the two clamping parts abut the two end surfaces of the ingot so that the two clamping parts of the end surface clamping jig fix the ingot. Subsequently, the ingot may be fixed to a specific device (e.g., a lathe) by utilizing the end surface clamping jig for subsequent procedures (e.g., edge polishing). Compared with the conventional fixing of the shaft rod to the ingot by adhesion, in which applying adhesives and removing adhesives are relatively time-consuming, the ingot jig assembly of the disclosure can be rapidly fixed to or separated from the ingot, which is relatively time-saving and convenient.

In addition, in the ingot edge-polishing machine tool of the disclosure, the first limiting assembly is detachably disposed on the case body and configured to limit the position of the support base on the first axis. Also, the second limiting assembly of the ingot edge-polishing machine tool is detachably disposed on the case body and configured to limit the position of the polishing assembly on the first axis. The support base of the ingot edge-polishing machine tool is movably disposed on the case body along the first axis and is adapted to support the ingot. Moreover, the polishing assembly is movably disposed above the support base along the first axis. Therefore, when the ingot is located on the support base, the ingot may move along with the support base along the first axis to the position limited by the first limiting assembly, and then the polishing assembly moves along the first axis to the position limited by the second limiting assembly to be in contact with the edge of the ingot. Accordingly, the ingot edge-polishing machine tool is adapted for placing ingots of different dimensions. Moreover, the ingot fixing assembly of the ingot edge-polishing machine tool is rotatably disposed around the second axis and located between the support base and the polishing assembly. Subsequently, an end surface of the ingot is fixed by the ingot fixing assembly to ensure that the ingot is stable and still on the first axis. In other words, the positions of ingots of different dimensions relative to the ingot edge-polishing machine tool can be conveniently adjusted and fixed through cooperation of the support base, the polishing assembly, and the ingot fixing assembly, which facilitates operation of subsequent procedures (e.g., edge polishing). The ingot edge-polishing machine tool of the disclosure not only is convenient for adjusting the position of the ingot, but can also be rapidly fixed to or separated from the ingot, which is relatively time-saving.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An ingot edge-polishing machine tool comprising:
a case body;
a support base movably disposed on the case body along a first axis;
a first limiting assembly detachably disposed on the case body, the first limiting assembly configured to limit a position of the support base on the first axis;
a polishing assembly movably disposed above the support base along the first axis;
a second limiting assembly detachably disposed on the case body, the second limiting assembly configured to limit a position of the polishing assembly on the first axis; and
an ingot fixing assembly rotatably disposed around a second axis and located between the support base and the polishing assembly, wherein the support base is adapted to support an ingot, the ingot fixing assembly fixes an end surface of the ingot, and the polishing assembly is in contact with an edge of the ingot.

2. The ingot edge-polishing machine tool according to claim 1, further comprising:
a fall prevention assembly located beside the support base, wherein when the support base supports the ingot, the ingot is located between the ingot fixing assembly and the fall prevention assembly, and a height of the fall prevention assembly is greater than half of a distance between the support base and the polishing assembly.

3. The ingot edge-polishing machine tool according to claim 2, wherein the fall prevention assembly comprises two stop parts movably disposed on the case body to be away from or close to each other, a first distance between the two stop parts is less than a diameter of the end surface of the ingot when the two stop parts are close to each other, and a second distance between the two stop parts is greater than the diameter of the end surface of the ingot when the two stop parts are away from each other.

4. The ingot edge-polishing machine tool according to claim 1, further comprising:
an ingot positioning member movably disposed on the case body along a third axis and located between the support base and the polishing assembly.

5. The ingot edge-polishing machine tool according to claim 1, further comprising:
a first driving assembly driving the support base to move along the first axis;
a second driving assembly driving the polishing assembly to move along the first axis;
a third driving assembly driving the ingot fixing assembly to rotate; and
an electrically control assembly disposed on the case body and electrically connected to the first driving assembly, the second driving assembly, and the third driving assembly.

6. The ingot edge-polishing machine tool according to claim 1, wherein the ingot fixing assembly comprises a suction nozzle rotatably disposed around the second axis and a vacuum pump in communication with the suction nozzle.

7. The ingot edge-polishing machine tool according to claim 1, further comprising:
a fourth driving assembly, wherein the polishing assembly comprises a first polishing element and a second polishing element, a roughness of the first polishing element is different from a roughness of the second polishing element, and the fourth driving assembly rotates one of the first polishing element and the second polishing element to a position directly above the support base and rotates the other one away from the position directly above the support base.

8. The ingot edge-polishing machine tool according to claim 1, further comprising:
a polishing liquid recovering tank located below the support base;
a pump in communication with the polishing liquid recovering tank; and
a pipeline in communication with the pump, the pipeline extending to a position above the polishing assembly.

9. The ingot edge-polishing machine tool according to claim 1, wherein the case body comprises a first limiting region threaded hole close to the support base and a second limiting region threaded hole close to the polishing assembly,
the first limiting assembly comprises a first limiting element and a second limiting element having different heights, wherein one of the first limiting element and the second limiting element is selectably threadably engaged with the first limiting region threaded hole to limit the position of the support base on the first axis, and
the second limiting assembly comprises a third limiting element and a fourth limiting element having different heights, wherein one of the third limiting element and the fourth limiting element is selectably threadably engaged with the second limiting region threaded hole to limit the position of the polishing assembly on the first axis.

10. The ingot edge-polishing machine tool according to claim 9, wherein the case body comprises a first temporary storage region threaded hole and a second temporary storage region threaded hole, the other one of the first limiting element and the second limiting element is threadably engaged with the first temporary storage region threaded hole, and the other one of the third limiting element and the fourth limiting element is threadably engaged with the second temporary storage region threaded hole.
